(19) United States
(12) Patent Application Publication
(10) Pub. No.: US 2006/0263670 A1
(43) Pub. Date: Nov. 23, 2006

(54) Fuel cell bipolar plate

(75) Inventor: Fumio Tanno, Okazaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NISSHINBO INDUSTRIES, INC., Tokyo (JP)

(21) Appl. No.: 11/437,659

(22) Filed: May 22, 2006

(30) Foreign Application Priority Data
May 23, 2005 (JP) 2005-149260

(51) Int. Cl. H01M 8/02; H01B 1/24

(52) U.S. Cl. 429/38; 252/511

(57) ABSTRACT

A fuel cell bipolar plate obtained by subjecting a body shaped from a specific composition to surface roughening treatment and atmospheric pressure plasma treatment has a gas flow channel face with specific surface characteristics which endow the bipolar plate with an excellent and long-lasting hydrophilicity that enables water which forms during power generation by the fuel cell to be easily drained off, and which also provide the bipolar plate with a low contact resistance with electrodes in the fuel cell.

### CROSS-REFERENCE TO RELATED APPLICATION

This non-provisional application claims priority under 35 U.S.C. §119(a) on Patent Application No. 2005-149260 filed in Japan on May 23, 2005, the entire contents of which are hereby incorporated by reference.

### BACKGROUND OF THE INVENTION

1. Field of the Invention

The present invention relates to a fuel cell bipolar plate.

2. Prior Art

Fuel cells are devices which, when supplied with a fuel such as hydrogen and with atmospheric oxygen, cause the fuel and oxygen to react electrochemically, producing water and directly generating electricity. Because fuel cells are capable of achieving a high fuel-to-energy conversion efficiency and are environmentally adaptable, they are being developed for a variety of applications, including small-scale local power generation, household power generation, simple power supplies for isolated facilities such as campgrounds, mobile power supplies such as for automobiles and small boats, and power supplies for satellites and space development.

Such fuel cells, and particularly solid polymer fuel cells, are built in the form of modules composed of a stack of at least several tens of unit cells. Each unit cell has a pair of plate-like bipolar plates with raised areas on either side thereof that define a plurality of channels for the flow of gases such as hydrogen and oxygen. Disposed between the pair of bipolar plates in the unit cell are a solid polymer electrolyte membrane and gas diffusing electrodes made of carbon paper.

One role of the fuel cell bipolar plates is to confer each unit cell with electrical conductivity. In addition, the bipolar plates provide flow channels for the supply of fuel and air (oxygen) to the unit cells and also serve as separating boundary walls. Characteristics required of the bipolar plates thus include a high electrical conductivity, a high gas impermeability, electrochemical stability and hydrophilicity.

The water formed by the reaction between the gases during power generation by the fuel cell is known to have a large effect on the fuel cell characteristics. Of the properties desired in a fuel cell, the ability to rapidly drain off water that has formed during power generation is the most important. Because this ability to drain off water depends on the hydrophilicity of the bipolar plate, there exists a need to enhance this hydrophilicity.

Techniques for enhancing the hydrophilicity of bipolar plate include (1) coating the surface of the bipolar plate with a hydrophilic inorganic powder (JP-A 58-150278), (2) bonding a sheet of hydrophilic inorganic fibers and organic fibers to the surface of the bipolar plate (JP-A 63-110555), (3) bonding to the bipolar plate a preformed sheet in which have been incorporated hydrophilic inorganic fibers and powder or hydrophilic organic fibers and powder (JP-A 10-3931), (4) dipping into acid the portions of the bipolar plate that will come into contact with electrodes (JP-A 11-297388), and (5) atmospheric pressure discharge plasma treating the fuel cell bipolar plate (JP-A 2002-25570).

However, in above method (1), the hydrophilic layer composed of inorganic powder that has been coated onto the bipolar plate surface is subject to peeling or wear during fuel cell assembly. As a result, the hydrophilicity enhancing effect tends to be inadequate.

In method (2), the sheet on the bipolar plate surface may separate off or may crease on the flow channel side, lowering the hydrophilicity of the bipolar plate and its ability to remove water.

In method (3), the incorporation of a large amount of inorganic fibers or organic fibers to enhance the hydrophilic properties gives rise to a new problem—a decline in the electrical conductivity.

In method (4), acidic solution remaining in the bipolar plate may leach out during fuel cell operation or may dissolve resin within the bipolar plate.

In method (5), the hydrophilized surface has a poor durability, in addition to which the hydrophilicity and water removing ability decline significantly over time.

### SUMMARY OF THE INVENTION

It is therefore an object of the invention to provide fuel cell bipolar plates which have a high hydrophilicity that enables water which forms as a result of power generation by the fuel cell to be easily drained off, which are able to maintain a good hydrophilicity for a relatively long period of time, and which have a low contact resistance with electrodes in the fuel cell.

I have discovered that, by subjecting a body shaped from a composition that includes a thermoset resin, a graphite material having an average particle diameter within a specific range and an internal release agent to both surface roughening treatment and atmospheric pressure plasma treatment so as to form a fuel cell bipolar plate, and by also having the average roughness Ra of the bipolar plate surface fall within a specific range at that time, the hydrophilicity can be increased and a good hydrophilicity can be maintained for a relatively long period of time, in addition to which the contact resistance with electrodes in the fuel cell can be minimized.

Accordingly, the invention provides a fuel cell bipolar plate which is obtained by subjecting a body shaped from a composition that includes a thermoset resin, a graphite material having an average particle diameter of 20 to 80 μm and an internal release agent to surface roughening treatment and atmospheric pressure plasma treatment, and which has a gas flow channel face with an average roughness Ra of 1.0 to 5.0 μm, an average spacing between peaks Sm of 100 to 200 μm, and a static contact angle of 20 to 70°.

Preferably, only the gas flow channel face has an average roughness Ra of 1.0 to 5.0 μm, an average spacing between peaks Sm of 100 to 200 μm, and a static contact angle of 20 to 70°.

The fuel cell bipolar plate has a wetting tension of preferably at least 60 mN/m, and has a contact resistance of preferably 3.5 to 7 mΩ·cm².

Typically, the surface roughening treatment is shot blasting with alumina abrasive grain having a grit size of #150 to 320 (an average particle diameter of 40 to 89 μm).

The fuel cell bipolar plate preferably has a static contact angle, after the bipolar plate has been held for one month under conditions of atmospheric pressure, 40% relative humidity and 25° C., of 20 to 70°.

The fuel cell bipolar plate preferably has a wetting tension, after the bipolar plate has been held for one month under conditions of atmospheric pressure, 40% relative humidity and 25° C., of at least 60 mN/m.

The composition from which the fuel cell bipolar plate is made typically includes 10 to 30 parts by weight of the thermoset resin and 0.1 to 1.5 parts by weight of the internal release agent per 100 parts by weight of the graphite material.

Because it is obtained by subjecting a body shaped from a composition that includes a thermoset resin, a graphite material having an average particle diameter of 20 to 80 μm and an internal release agent to surface roughening treatment and atmospheric pressure plasma treatment, and because it has a gas flow channel face with an average roughness Ra of 1.0 to 5.0 μm, an average spacing between peaks Sm of 100 to 200 μm and a static contact angle of 20 to 70°, the fuel cell bipolar plate of the invention is endowed with an excellent hydrophilicity which enables water that has formed as a result of power generation by the fuel cell to be easily drained off, is able to maintain a good hydrophilicity and wetting tension for a relatively long time, and has a low contact resistance. Fuel cells provided with the inventive fuel cell bipolar plates are thus capable of maintaining a stable power generating efficiency over an extended period of time.

### DETAILED DESCRIPTION OF THE INVENTION

As noted above, the fuel cell bipolar plate of the invention is obtained by subjecting a body shaped from a composition that includes a thermoset resin, a graphite material having an average particle diameter of 20 to 80 μm and an internal release agent to surface roughening treatment and atmospheric pressure plasma treatment. The fuel cell bipolar plate has a gas flow channel face with an average roughness Ra of 1.0 to 5.0 μm, an average spacing between peaks Sm of 100 to 200 μm, and a static contact angle of 20 to 70°.

In the practice of the invention, the thermoset resin is not subject to any particular limitation. Use may be made of any of the various types of thermoset resins from which fuel cell bipolar plates have hitherto been molded or formed. Illustrative examples include any one or combination of two or more of the following: resole-type phenolic resins, epoxy resins, polyester resins, urea resins, melamine resins, silicone resins, vinyl ester resins, diallyl phthalate resins and benzoxazine resins. Of these, benzoxazine resins, epoxy resins and resole-type phenolic resins are preferred on account of their excellent heat resistance and mechanical strength.

The composition which includes a thermoset resin, a graphite material having an average particle diameter of 20 to 80 μm and an internal release agent (which composition is referred to hereinafter as the “fuel cell bipolar plate-forming composition”) has a thermoset resin content that, while not subject to any particular limitation, is preferably 10 to 30 parts by weight, and more preferably 15 to 25 parts by weight, per 100 parts by weight of the graphite material. At a thermoset resin content of less than 10 parts by weight, fuel cell bipolar plates made from the composition may be subject to gas leakage and have a decreased strength. On the other hand, at more than 30 parts by weight, such bipolar plates may have a decreased electrical conductivity.

Illustrative, non-limiting, examples of the graphite material include graphite obtained by firing needle coke or lump coke, graphite obtained by grinding electrodes to a powder, coal pitch, petroleum pitch, coke, activated carbon, glassy carbon, acetylene black, carbon black and Ketjenblack. Any one or combination of two or more thereof may be used. Of these, graphite obtained by firing needle coke at 2,000 to 3,000° C. is preferred on account of its high degree of graphitization and excellent electrical conductivity.

In the practice of the invention, the graphite material has an average particle diameter of 20 to 80 μm, preferably 30 to 70 μm, and most preferably 40 to 60 μm.

At an average particle diameter of less than 20 μm, the thermoset resin readily coats the surface of the graphite, lowering the surface area of contact between graphite particles and very likely diminishing the electrical conductivity of the bipolar plate itself. On the other hand, at an average particle diameter of more than 80 μm, the thermoset resin tends to make its way into pores between the graphite particles, lowering the surface area of contact between the particles. Here too, the likely result is a decline in the electrical conductivity of the bipolar plate.

Hence, a graphite material having an average particle diameter outside the range specified herein encourages the formation of a thermoset resin layer on the surface of the graphite particles or in pores between the particles. In either case, it is very likely that the bipolar plate itself will have a lower electrical conductivity.

Although a bipolar plate which is molded or formed from a composition containing a graphite powder having an average particle diameter within a range of 20 to 80 μm generally has at the surface thereof a layer of thermoset resin between the graphite particles, by setting the surface roughness of the bipolar plate to the average roughness Ra specified below, this thermoset resin layer is removed, enabling a bipolar plate to be achieved which has an excellent hydrophilicity and a low contact resistance.

To further improve the hydrophilic properties of the fuel cell bipolar plate and the contact resistance-lowering effects, it is preferable for the graphite powder to have an average particle diameter of 30 to 70 μm and to contain not more than 5% of particles having a diameter of 5 μm or less and not more than 3% of particles having a diameter of 100 μm or more. A graphite powder which has an average particle diameter of 40 to 60 μm and contains not more than 5% of particles having a diameter of 5 μm or less and not more than 1% of particles having a diameter of 100 μm or more is most preferred.

“Average particle diameter” refers herein to a value measured using a Microtrak particle size analyzer.

The internal release agent may be any internal release agent that has hitherto been used in the molding or forming of bipolar plates. Illustrative examples include stearic acid-based waxes, amide-based waxes, montanic acid-based waxes, carnauba wax and polyethylene waxes. These may be used singly or as combinations of two or more thereof.

The content of internal release agent in the fuel cell bipolar plate-forming composition, while not subject to any particular limitation, is preferably 0.1 to 1.5 parts by weight, and more preferably 0.3 to 1.0 part by weight, per 100 parts by weight of the graphite powder. At an internal release agent content of more than 1.5 parts by weight, problems such as bleeding of the internal release agent to the bipolar plate surface may arise.

The fuel cell bipolar plate of the invention has a gas flow channel face with an average roughness Ra of 1.0 to 5.0 μm and an average spacing between peaks Sm of 100 to 200 μm.

At an average roughness Ra of less than 1.0 μm or an average spacing between peaks Sm of less than 100 μm, the surface tension of water is maintained, making it easier for water to aggregate within the flow channels formed in the bipolar plate surface. Moreover, the presence of a thermoset resin layer between the graphite particles at the surface of the bipolar plate reduces the surface area of contact between an adjoining electrode and the graphite, making an increase in the contact resistance very likely. On the other hand, at an average roughness Ra of more than 5.0 μm or an average spacing between peaks Sm of more than 200 μm, the hydrophilicity is enhanced, but the bipolar plate surface has a tendency to shed graphite. Hence, in the latter case as well, there is a high likelihood that the bipolar plate will have an undesirably small surface area of contact with adjoining electrodes and an increased contact resistance.

By contrast, at an average roughness Ra of 1.0 to 5.0 μm and an average spacing between peaks Sm of 100 to 200 μm, the balance in the surface tension of water breaks down, enhancing the hydrophilicity on the inner faces of the flow channels formed at the surface of the bipolar plate. Moreover, the thermoset resin layer at the surface of the bipolar plate is removed, thus increasing the surface area of contact with adjoining electrodes and making it possible to lower the contact resistance.

To additionally enhance the hydrophilicity of the fuel cell bipolar plate and increase even further the contact resistance-lowering effect, the average surface roughness Ra is more preferably 1.5 to 5.0 μm, and even more preferably 3.5 to 4.0 μm, and the average spacing between peaks Sm is more preferably 120 to 200 μm, and even more preferably 170 to 200 μm.

In the practice of the invention, roughening treatment of the bipolar plate surface is preferably carried out by shot blasting. The most preferred technique involves the use of an alumina abrasive grain (sometimes referred to below as “WA”) having a grit size of #150 to 320 (an average particle diameter of 40 to 89 μm) to suitably set the average roughness Ra within a range of 1.0 to 5.0 μm.

Here, if WA has a grit size of less than #150 (an average particle diameter of 79 to 89 μm), surface treatment to an average roughness Ra of 1.0 μm or more is difficult, as a result of which resin tends to remain on the surface layer. At a grit size of more than #320 (an average particle diameter of 40 to 50 μm), the abrasive grain is too coarse, which tends to result in uneven surface treatment and may thus allow resin to remain on the surface layer.

To more efficiently remove resin that is present on the surface layer of the fuel cell bipolar plate, the use of WA having a grit of #180 to 280 (an average particle diameter of 47 to 75 μm) is even more preferred. The use of WA having a grit of #220 to 240 (an average particle diameter of 54 to 66 μm) is especially preferred.

In the fuel cell bipolar plate of the invention, at least the gas flow channel face has a static contact angle in a range of 20 to 70°.

At a contact angle of less than 20°, the speed of travel by the hot electrode in plasma treatment must be slowed, which may lower the production efficiency and increase costs. On the other hand, at a contact angle of more than 70°, the wettability is too low, as a result of which water generated during operation of the fuel cell may not drain from the bipolar plate.

In the invention, following surface roughening treatment, the static contact angle of the bipolar plate is set within the above range by administering atmospheric pressure plasma treatment.

The technique used to carry out atmospheric pressure plasma treatment is not subject to any particular limitation. For example, suitable use may be made of a known atmospheric pressure plasma treatment process such as oxygen gas plasma treatment or nitrogen gas plasma treatment under atmospheric pressure. The use of oxygen gas plasma treatment or nitrogen gas plasma treatment applied with an atmospheric pressure plasma surface treatment system (AP-T02-S, manufactured by Sekisui Chemical Co., Ltd.) is preferred when working the present invention.

The fuel cell bipolar plate of the invention has a wetting tension of preferably at least 60 mN/m, and more preferably at least 65 mN/m. At a wetting tension of less than 60 mN/m, the wettability is inadequate and water generated during operation of the fuel cell may not drain from the fuel cell. Although there is no particular upper limit in the wetting tension, it is preferable for the wetting tension to be not more than about 73 mN/m.

The fuel cell bipolar plate of the invention has a contact resistance of preferably 3.5 to 7 mΩ·cm², and more preferably 5 to 7 mΩ·cm². At a contact resistance greater than 7 mΩ·cm², the electrical conductivity is inadequate, which may lower the ability of the fuel cell to generate electricity.

In the inventive fuel cell bipolar plate, by carrying out both surface roughening treatment and atmospheric pressure plasma treatment, the hydrophilicity and wettability can be effectively prevented from deteriorating over time.

That is, the fuel cell bipolar plate of the invention which has been obtained through the use of both these two surface treatments, when held for one month under conditions of atmospheric pressure, 40% relative humidity and 25° C., is able to maintain a static contact angle of 20 to 70° and a wetting tension of at least 60 mN/m.

In the inventive fuel cell bipolar plate, it suffices to carry out both the surface roughening treatment and the atmospheric pressure plasma treatment at least on the gas flow channel faces that come into contact with the water that forms during power generation, although these treatments may be administered to the entire surface of the bipolar plate.

When surface treatment is administered only to the gas flow channel face, areas that do not require surface treatment are masked. The masking material and method used at this time may be selected from among materials and methods that are known to be suitable for this purpose.

The fuel cell bipolar plate of the invention is obtained by subjecting a body shaped from the fuel cell bipolar plate-forming composition to the above-described surface roughening treatment and atmospheric pressure plasma treatment. Any of various known methods for preparing the composition and for shaping a body from the composition may be used without particular limitation.

For example, preparation of the composition may be carried out by mixing in any order and in the required proportions the above-mentioned thermoset resin, graphite material and internal release agent. Examples of mixers that may be used for this purpose include planetary mixers, ribbon blenders, Loedige mixers, Henschel mixers, rocking mixers and Nauta mixers. The method for shaping the bipolar plate also is not subject to any particular limitation. For example, use can be made of injection molding, transfer molding, compression molding, extrusion or sheet thermoforming.

In addition to the above-indicated materials, the fuel cell bipolar plate of the invention may also contain other ingredients, including various types of fibers (e.g., carbon fibers, organic fibers such as cellulose fibers, and inorganic fibers) and inorganic fillers (e.g., alumina, silica, silicon carbide), insofar as the objects of the invention are not compromised.

The above-described fuel cell bipolar plate of the invention has an excellent hydrophilicity, maintains a good hydrophilicity for a relatively long period of time, and has a low contact resistance. Therefore, fuel cells provided with such bipolar plates are able to maintain a stable power generating efficiency over an extended period of time. Fuel cell bipolar plates endowed with such properties are particularly well-suited for use as bipolar plates in solid polymer fuel cells.

A solid polymer fuel cell is generally composed of a stack of many unit cells, each of which is constructed of a solid polymer membrane disposed between a pair of electrodes that are in turn sandwiched between a pair of bipolar plates which form channels for the supply and removal of gases. The fuel cell bipolar plate of the invention can be used as some or all of the plurality of bipolar plates in the fuel cell.

### EXAMPLES

The following Examples and Comparative Examples are provided to illustrate the invention and are not intended to limit the scope thereof. Average particle diameters given below are values measured using a Microtrak particle size analyzer.

### Examples 1 to 13

### Comparative Examples 1 to 9

In each example, a fuel cell bipolar plate-forming composition was prepared by charging a Henschel mixer with 100 parts by weight of artificial graphite powder having the average particle diameter shown in Table 1, 24 parts by weight of phenolic resin as the thermoset resin and 0.3 part by weight of carnauba wax as the internal release agent, then mixing for 3 minutes at 1,500 rpm.

The resulting composition was poured into a 300×300 mm mold and compression molded at a mold temperature of 180° C., a molding pressure of 29.4 MPa and a molding time of 2 minutes to form shaped bodies. In Examples 1 to 9 according to the invention and in Comparative Examples 1 to 6 and 8, the subsequently described surface roughening treatment and oxygen gas plasma treatment were both administered to the entire surface of the resulting shaped body. In Examples 10 to 13, surface roughening treatment and nitrogen gas plasma treatment were both administered. Only oxygen gas plasma treatment was administered in Comparative Example 7, and only surface roughening treatment was administered in Comparative Example 9. Fuel cell bipolar plate samples having the surface properties indicated in Table 1 were thus obtained.

Surface Roughening Treatment Method

The shaped body in each example was surface treated by shot blasting (using an AMC 127 shot blasting machine manufactured by Nicchu Co., Ltd.) with WA having the grit size shown in Table 1 at a nozzle pressure of 0.25 MPa and a bipolar plate transport speed of 0.5 m/min.

Oxygen Gas Plasma Treatment Method

Surface treatment was administered with an atmospheric pressure plasma surface treatment system (AP-T02-S; manufactured by Sekisui Chemical Co., Ltd.) at an oxygen gas flow rate of 20 L/min and an electrode movement speed of 0.2 m/min.

Nitrogen Gas Plasma Treatment Method

Surface treatment was administered with an atmospheric pressure plasma surface treatment system (AP-T02-S; Sekisui Chemical Co., Ltd.) at a nitrogen gas flow rate of 20 L/min and an electrode movement speed of 0.2 m/min.

The fuel cell bipolar plate samples obtained in the above examples and comparative examples were measured and evaluated for average surface roughness Ra, average spacing between peaks Sm, contact resistance, contact angle (both immediately after production and one month after production), and wetting tension (both immediately after production and one month after production). The results are presented in Table 1. The measurement and evaluation methods that were used are described below.

1. Average Roughness Ra and Average Spacing Between Peaks Sm

Ra and Sm were measured in accordance with JIS B0601-1994 using a surface roughness tester (Surfcom 1800D, available from Tokyo Seimitsu Co., Ltd.) having a probe tip diameter of 5 μm.

2. Contact Resistance

(1) Carbon Paper+Bipolar Plate Sample

Two sheets of the respective bipolar plate samples obtained as described above were stacked together, and carbon paper (TGP-H060, available from Toray Industries, Inc.) was placed above and below the two stacked bipolar plate samples. Copper electrodes were placed above and below the resulting stack. A surface pressure of 1 MPa was then applied vertically to the entire stack, and the voltage was measured by a four-terminal method.

(2) Carbon Paper

Copper electrodes were placed above and below a sheet of carbon paper, following which a surface pressure of 1 MPa was applied vertically thereto and the voltage was measured by a four-terminal method.

(3) Method for Computing Contact Resistance

The voltage drop between the bipolar plate samples and the carbon paper was determined from the respective voltages obtained in (1) and (2) above, and the contact resistance was computed as follows.
Contact Resistance=(voltage drop×surface area of contact)/current
3. Contact Angle

A contact angle meter (model CA-DT A, manufactured by Kyowa Interface Science Co., Ltd.) was used to measure the contact angle immediately after production of the fuel cell bipolar plate, and after holding the fuel cell bipolar plate for one month under conditions of atmospheric pressure, 40% relative humidity and 25° C.

4. Wetting Tension

The wetting tension was measured based on JIS K6768 (Test Method for Wetting Tension of Plastic Films), both immediately after production of the fuel cell bipolar plate and after holding the fuel cell bipolar plate for one month under conditions of atmospheric pressure, 40% relative humidity and 25° C.

TABLE 1

| | | Graphite | | | | | | | | |
|---|---|---|---|---|---|---|---|---|---|---|
| | | powder | | Average | | | Contact angle | | Wetting tension | |
| | | average | Grit | surface | | | (°) | | (mN/m) | |
| | | particle | size of | roughness | | Contact | Just | | Just | |
| | | diameter | abrasive | Ra | Sm | resistance | after | After | after | After |
| | | (μm) | grains | (μm) | (μm) | (mΩ · cm²) | production | 1 month | production | 1 month |
| Example | 1 | 30 | 150 | 4.0 | 188 | 6.5 | 20 | 67 | 73 | 70 |
| | 2 | 30 | 220 | 3.5 | 180 | 6.0 | 28 | 67 | 70 | 67 |
| | 3 | 30 | 300 | 1.5 | 135 | 6.0 | 31 | 67 | 67 | 65 |
| | 4 | 50 | 150 | 4.2 | 198 | 5.7 | 24 | 67 | 73 | 70 |
| | 5 | 50 | 220 | 3.3 | 180 | 5.6 | 26 | 65 | 70 | 67 |
| | 6 | 50 | 300 | 1.2 | 140 | 5.6 | 33 | 65 | 67 | 65 |
| | 7 | 70 | 150 | 4.6 | 200 | 5.2 | 20 | 67 | 73 | 70 |
| | 8 | 70 | 220 | 4.0 | 192 | 5.0 | 24 | 67 | 70 | 67 |
| | 9 | 70 | 300 | 1.0 | 113 | 5.0 | 35 | 65 | 67 | 65 |
| | 10 | 50 | 150 | 4.0 | 198 | 5.7 | 26 | 65 | 73 | 70 |
| | 11 | 50 | 220 | 3.5 | 180 | 5.6 | 33 | 67 | 70 | 67 |
| | 12 | 70 | 150 | 4.6 | 200 | 5.7 | 24 | 67 | 73 | 70 |
| | 13 | 70 | 220 | 4.0 | 192 | 5.6 | 35 | 65 | 73 | 70 |
| Comparative | 1 | 10 | 150 | 3.3 | 198 | 15.1 | 26 | 69 | 65 | 61 |
| Example | 2 | 10 | 220 | 2.5 | 198 | 14.6 | 26 | 70 | 65 | 63 |
| | 3 | 10 | 300 | 0.5 | 100 | 25.1 | 35 | 110 | 60 | 40 |
| | 4 | 100 | 150 | 3.5 | 200 | 15.3 | 40 | 70 | 60 | 60 |
| | 5 | 100 | 220 | 4.0 | 215 | 14.8 | 40 | 70 | 60 | 60 |
| | 6 | 100 | 300 | 0.6 | 115 | 20.5 | 28 | 110 | 60 | 35 |
| | 7 | 50 | — | 0.1 | 10 | 110 | 40 | 110 | 60 | 30 |
| | 8 | 50 | 400 | 0.4 | 77 | 20.0 | 40 | 110 | 70 | 34 |
| | 9 | 50 | 220 | 3.5 | 196 | 5.5 | 110 | 110 | 65 | 65 |

As is apparent from the results in Table 1, because the fuel cell bipolar plates obtained in the above examples according to the invention were made using a graphite material having an average particle diameter of 20 to 80 μm, were administered surface roughening treatment and atmospheric pressure plasma treatment, and had an average surface roughness Ra of 1.0 to 5.0 μm, an average spacing between peaks Sm of 100 to 200 μm, and a static contact angle of 20 to 70°, their contact resistances were held to lower levels than in the fuel cell bipolar plates obtained in the comparative examples, in addition to which they had a higher wettability.

Also, in each of the fuel cell bipolar plates according to the invention, the contact angle after one month was held to a lower value and the wetting tension after one month was held to a higher value than in the fuel cell bipolar plate obtained in Comparative Example 7, which was not subjected to surface roughening treatment. Moreover, the fuel cell bipolar plates according to the invention had a lower contact angle than the fuel cell bipolar plate obtained in Comparative Example 9, which was not administered atmospheric pressure plasma treatment.

Japanese Patent Application No. 2005-149260 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A fuel cell bipolar plate obtained by subjecting a body shaped from a composition comprising a thermoset resin, a graphite material having an average particle diameter of 20 to 80 μm and an internal release agent into a shaped body to surface roughening treatment and atmospheric pressure plasma treatment, which bipolar plate has a gas flow channel face with an average roughness Ra of 1.0 to 5.0 μm, an average spacing between peaks Sm of 100 to 200 μm, and a static contact angle of 20 to 70°.

2. The fuel cell bipolar plate of claim 1, wherein only the gas flow channel face has an average roughness Ra of 1.0 to 5.0 μm, an average spacing between peaks Sm of 100 to 200 μm, and a static contact angle of 20 to 70°.

3. The fuel cell bipolar plate of claim 1 which has a wetting tension of at least 60 mN/m.

4. The fuel cell bipolar plate of claim 1 which has a contact resistance of 3.5 to 7 mΩ·cm².

5. The fuel cell bipolar plate of claim 1, wherein the surface roughening treatment is shot blasting with alumina abrasive grain having a grit size of #150 to 320 (an average particle diameter of 40 to 89 μm).

6. The fuel cell bipolar plate of claim 1, wherein the static contact angle, after the bipolar plate has been held for one month under conditions of atmospheric pressure, 40% relative humidity and 25° C., is 20 to 70°.

7. The fuel cell bipolar plate of claim 3, wherein the wetting tension, after the bipolar plate has been held for one month under conditions of atmospheric pressure, 40% relative humidity and 25° C., is at least 60 mN/m.

8. The fuel cell bipolar plate of claim 1, wherein the composition includes 10 to 30 parts by weight of the thermoset resin and 0.1 to 1.5 parts by weight of the internal release agent per 100 parts by weight of the graphite material.
